(19) United States
(12) Patent Application Publication
(10) Pub. No.: US 2006/0277412 A1
(43) Pub. Date: Dec. 7, 2006

(54) Method and System for Secure Payer Identity Authentication

(76) Inventor: Sameer Mandke, Katy, TX (US)

Correspondence Address: CONLEY ROSE, P.C., P. O. BOX 3267, HOUSTON, TX, 77253-3267, US

(21) Appl. No.: 11/419,715

(22) Filed: May 22, 2006

Related U.S. Application Data
(60) Provisional application No. 60/683,196, filed on May 20, 2005.
(60) Provisional application No. 60/698,054, filed on Jul. 11, 2005.

(51) Int. Cl. H04K 1/00

(52) U.S. Cl. 713/186

(57) ABSTRACT

The present disclosure describes a method and system for secure payer identity authentication. Some illustrative embodiments include a method that includes determining which of a plurality of real-time biometric data sample types can be provided by a holder of a payment instrument, randomly selecting a first stored biometric data sample from a plurality of stored biometric data samples, soliciting a first real-time biometric data sample from the holder corresponding to the first stored biometric data sample, and authenticating the identity of the holder if the first realtime biometric data sample matches the first stored biometric data sample.

### CROSS-REFERENCE TO RELATED APPLICATIONS

The present application claims the benefit of provisional application Ser. No. 60/683196, filed May 20, 2005 and entitled “Payer Authentication Security System,” and provisional application Ser. No. 60/698054, filed Jul. 11, 2005 and also entitled “Payer Authentication Security System,” both of which are herein incorporated by reference.

### BACKGROUND

In recent years the Internet has become an increasingly popular option as a means of accessing providers of products. As shoppers continue to shift from brick and mortar stores to online stores, more and more transactions are being paid for by consumers using credit cards, or other similar credit and debit mechanisms. But unlike a brick and mortar store, online stores are limited in their ability to confirm whether the party presenting payment is in fact authorized to use the instrument presented as a means for payment. Although online merchants frequently ask for additional information that presumably only the owner of the payment instrument would know (e.g., the cardholder's billing address on file with the issuer of a credit card), such information can be compromised in a number of ways (e.g., “phishing” by unscrupulous individuals via phone or e-mail), and generally is not considered a secure means of identity verification. Further, an increasing number of brick and mortar stores are automating their payment systems (e.g., pay at the pump gas stations and self-checkout grocery stores), and as a result are increasingly facing the same identity verification issues as online merchants.

Some identity verification systems use passwords or other secret information that may be compromised almost as easily as a cardholder's billing address, or are so cumbersome to utilize that the average consumer simply will not use them. Still other systems utilize biometric data associated with a particular individual (e g., a credit card holder) for identity verification, which may be susceptible to “spoofing.” Artificial means may be utilized with such systems to replicate the biometric data and fool the system into authenticating a transaction initiated by an individual pretending to be the actual holder or owner of the payment instrument.

### SUMMARY

The present disclosure describes a method and system for secure payer identity authentication. Some illustrative embodiments include a method that includes determining which of a plurality of real-time biometric data sample types can be provided by a holder of a payment instrument, randomly selecting a first stored biometric data sample from a plurality of stored biometric data samples, soliciting a first real-time biometric data sample from the holder corresponding to the first stored biometric data sample, and authenticating the identity of the holder if the first real-time biometric data sample matches the first stored biometric data sample.

Other illustrative embodiments include an information carrier medium comprising software that can be executed on a processor to cause the processor to determine which of a plurality of real-time biometric data sample types can be provided by a holder of a payment instrument, randomly select a first stored biometric data sample from a plurality of stored biometric data samples, solicit a first real-time biometric data sample from the holder, and authenticate the identity of the holder if the first real-time biometric data sample matches the first stored biometric data sample.

Yet further illustrative embodiments include a computer system that includes a processor, a communications interface coupled to the processor and configured to exchange messages across a communications network (wherein at least some of the messages identify a holder of a payment instrument), a non-volatile storage device coupled to the processor, one or more stored biometric data samples maintained on the non-volatile storage device, and software executing on the processor and configured to transmit and received messages using the communications interface, and further configured to store and retrieve the one or more biometric data samples. The holder is prompted by the software to provide one or more randomly selected real-time biometric data samples, each corresponding to one of the one or more stored biometric data samples. The identity of the holder is authenticated if each of the one or more real-time biometric samples matches the corresponding one or more stored biometric samples.

### BRIEF DESCRIPTION OF THE DRAWINGS

For a detailed description of the illustrative embodiments of the invention, reference will now be made to the accompanying drawings in which:

FIG. 1 shows how authentication data is exchanged between various parties, in accordance with at least some illustrative embodiments;

FIG. 2 shows an identification authentication server, constructed in accordance with at least some illustrative embodiments; and,

FIG. 3 shows a method for providing secure identification authentication, in accordance with at least some illustrative embodiments.

### NOTATION AND NOMENCLATURE

Certain terms are used throughout the following discussion and claims to refer to particular system components. This document does not intend to distinguish between components that differ in name but not function. In the following discussion and in the claims, the terms “including” and “comprising” are used in an open-ended fashion, and thus should be interpreted to mean “including but not limited to . . . .,” Also, the term “couple” or “couples” is intended to mean either an indirect or direct electrical connection. Thus, if a first device couples to a second device, that connection may be through a direct electrical connection, or through an indirect electrical connection via other devices and connections.

Additionally, the term “system” refers to a collection of two or more parts and may be used to refer to a computer system or a portion of a computer system. Further, the term “software” includes any executable code capable of running on a processor, regardless of the media used to store the software. Thus, code stored in non-volatile memory, and sometimes referred to as “embedded firmware,” is included within the definition of software.

The term “server” refers to a computer system that provides either local or remote access, or both, to one or more computer programs executing on the computer system. A server comprises one or more individual computers and/or computer peripheral components (e.g., processors and disk arrays) accessible by other computer systems (clients) through a communications network (e.g., the Internet). Also, the term “product” is intended to include both tangible and intangible goods, as well as services. Additionally, the term “biometric data” refers to any data representative of a sample or measurement of a biological characteristic of the individual providing the data.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

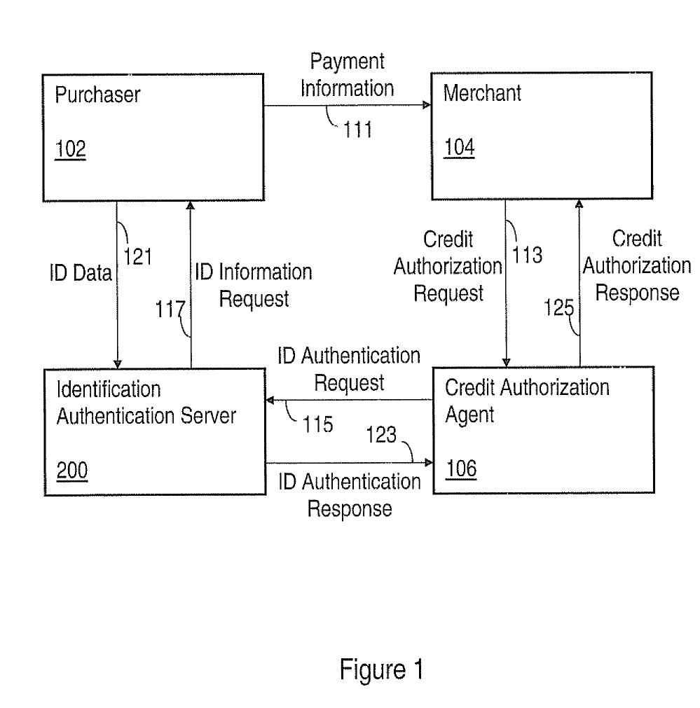

FIG. 1 shows how authorization and authentication request and response data is exchanged, in accordance with at least some illustrative embodiments of the invention. Purchaser 102 provides payment information 111 to merchant 104 (including information identifying a payment instrument) to pay for products (goods or services) that purchaser 102 wishes to acquire from merchant 104. The exchange may take place in person at an actual brick and mortar store, by telephone, or online over the Internet. In the embodiment of FIG. 1, payment information 111 is in the form of credit card information (e.g., amount of purchase, credit card number, name on the card, and expiration date), though information associated with other payment instruments may be used as well (e.g., PayPal® account information), and all such payment instruments are intended to be within the scope of the present disclosure.

Payment information 111 is passed by merchant 104 to credit authorization agent 106 as part of credit authorization request 113. In the illustrative embodiment of FIG. 1, credit authorization request 113 is made using existing credit authorization systems provided by banks and credit card issuers, and no modifications to existing interfaces and exchanges between merchant 104 and credit authorization agent 106 are required. Credit authorization agent 106 performs checks associated with authorizing the actual transaction, such as verifying the account information on file matches the information provided, or that the purchase amount does not cause the account balance to exceed any applicable credit limits. Credit authorization agent 106 also sends identification (ID) authentication request 115 to ID authentication server 200 ID authentication request 115 includes information that uniquely identifies the holder or owner of the payment instrument, such as, for example, an account holder's social security number.

Once ID authentication server 200 receives ID authentication request 115, the holder of record of the payment instrument presented to merchant 104 (e.g., purchaser 102) is contacted by ID authentication server 200 and a request for ID information (ID information request 117) is sent to purchaser 102, as is described in detail below. Purchaser 102 responds accordingly to the request by providing ID data 121 back to ID authentication server 200. ID authentication server 200 compares ID data 121 to stored authentication data samples, and the result of the comparison (matched or not matched) is provided by ID authentication server 200 back to credit authorization agent 106 as ID authentication response 123. The results of the ID authentication are then incorporated by credit authorization agent into the overall credit authorization decision, and an appropriate credit authorization response is sent back to merchant 104. Thus, for example, if the identity of purchaser 102 could not be verified, the transaction is not authorized. Similarly, if the identity of purchaser 102 is verified, then the transaction may or may not be authorized, depending upon such factors as, for example, whether the transaction would cause a credit account to exceed an authorized credit limit.

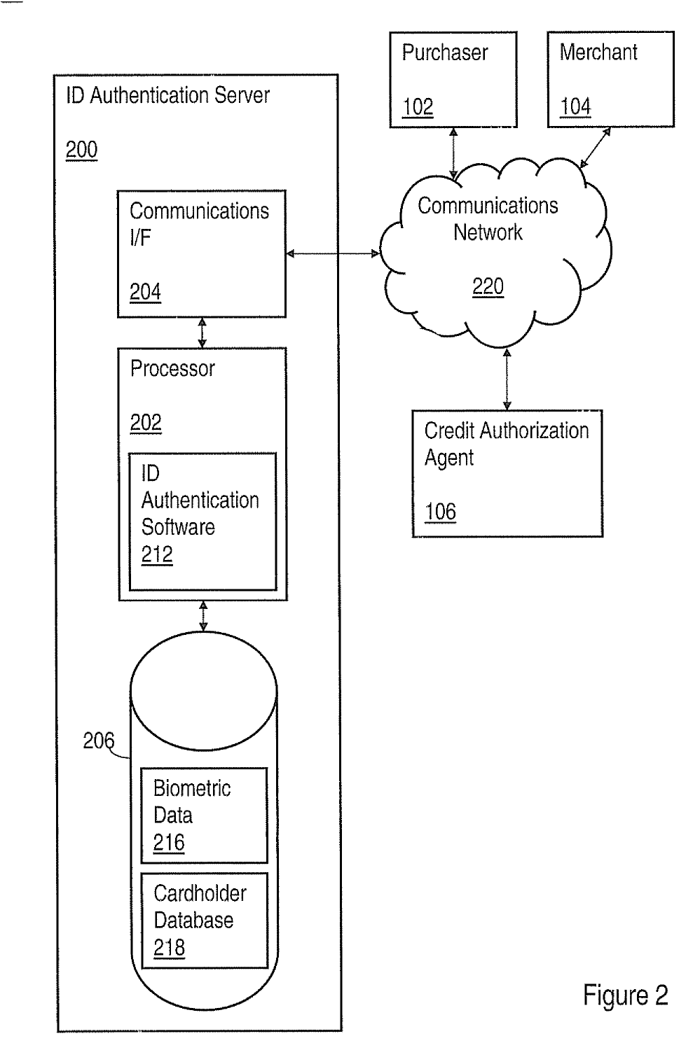

As already noted ID authentication server 200 processes requests for ID authentication and interacts with the holder of the payment instrument to verify the identity of the party presenting the payment instrument to merchant 104. FIG. 2 shows an illustrative embodiment of server 200, which includes processor 202 coupled to communications interface 204 and non-volatile storage device 206 (e.g., a hard disk drive). Communications interface 204 couples to communications network 220 and allows software executing on processor 202 to communicate with one or more external entities (e.g., a purchaser or a credit authorization agent).

Although communications network 220 is shown as a single network, it can comprise several distinct communications networks. These may include the Internet, public switched telephone networks (PSTNs), and cellular telephone networks, just to name a few. Thus, for example, merchant 104 may communicate with credit authorization agent 106 over a PSTN using a telephone-based credit authorization system, causing credit authorization agent 106 to communicate with ID authentication server 200 over the Internet, in turn causing ID authentication server 200 to communicate with purchaser 102 over a cellular telephone network. Many other types and combinations of communications networks will become apparent to those skilled in the art, and all such types and combinations are intended to be within the scope of the present disclosure.

Continuing to refer to the illustrative embodiment of FIG. 2, ID authentication software 212 executes on processor 202, and accesses biometric data within biometric database 216, stored on non-volatile storage device 206. When authentication software 212 receives an ID authentication request from an external entity (e.g., credit authorization agent 106), the software randomly selects one or more authentication criteria, which determines the type of information requested from the holder of record of the payment instrument presented. Although the purchaser may be the holder of record, the purchaser may also be another authorized user (e.g., a child of the holder of record). By configuring the system to contact the holder of record of the payment instrument, the holder of record can monitor and control the authorization of purchases made by such a secondary authorized user.

Biometric data samples corresponding to the selected criteria and stored within biometric database 216 are selected, and an attempt is made to contact the holder of record. The holder of record may be identified within a database (e.g., cardholder database 218) that is also stored on non-volatile device 206, and retrieved based upon a unique identifier (e.g., a social security number) provided as part of the received ID authentication request. The holder of record may be contacted by ID authentication software, for example, by placing a call to the holder's cellular telephone. The cellular telephone number dialed is also maintained as part of the holder's data that is stored on non-volatile device 206.

Additionally, multiple holders may be listed and ID authentication software 212 may be configured to sequentially attempt to contact each of them until a holder is successfully authenticated or the end of the list is reached. Alternatively, ID authentication software 212 may be configured to require that two or more holders be authenticated in order to authorize a purchase, for example, that exceeds a certain dollar amount. In this way, significant corporate purchases using a corporate payment instrument cannot be completed without proper approval by a predetermine number of corporate officers.

Once one or more holders of record of the payment instrument are contacted (depending on the configuration of ID authentication software 212), the contacted holder is prompted to provide a real-time biometric data sample for comparison to the randomly chosen biometric data selected from biometric database 216. The sample that is requested is based upon the type of data selected from biometric database 216. For example, if ID authentication server 200 contacts the holder of record by calling the holder's cellular telephone, the holder of record can provide a voice sample in response to an audible question or prompt. ID authentication server 200 maintains multiple samples within biometric database 216, each sample corresponding to the vocalized answer to a specific question or prompt. The samples are recorded by the holder of record and stored when ID authentication server 200 is initially configured to authorize purchases for the holder of record. Each sample is created by asking the holder of record to respond to a specific question or prompt, and by storing one or more sampled responses to the specific question or prompt. The stored responses are then used as described above to confirm a later response provided by the holder of record when authorizing a transaction. Existing techniques of voice identification are used to compare the live sample to the stored sample and thus confirm the identity of the party responding to the phone call. Such voice identification techniques are well known to those skilled in the art, and are not discussed further in the present disclosure.

By randomizing the selection of the stored sample, the security of the verification process is enhanced. This is due to the fact that although voice responses may be duplicated using artificial means (e.g., a voice recorder or digital voice synthesizer), the party attempting to simulate the holder's biometric data needs to know in advance what response will be requested. By storing multiple samples in response to a large number of simple questions or prompts, the unauthorized party must expend a significant amount of resources and effort to obtain, prepare and/or record responses to all possible questions or prompts that may be asked. By contrast, the holder of record already knows all the responses and thus does not expend any significant effort or incur any significant inconvenience in providing the responses to such inquiries from ID authentication server 200.

In at least some illustrative embodiments, the randomization described is not limited to just one type of biometric data. Other types of biometric data (e.g., retina scans, iris scans, and fingerprints) may also be used and combined to verify the identity of a person using a payment instrument. The availability of such other types of biometric data is limited only by the availability of the needed scanning equipment. If the device used by purchaser 102 to communicate with ID authentication server 200 has such additional scanning equipment, the purchaser may be asked to combine multiple data samples. Thus, for example, if a cell phone carried by the purchaser/holder had a built-in fingerprint scanner, the user could be asked to provide both a voice response to a randomly selected question or prompt and a fingerprint from a randomly selected finger. The combinations themselves are random in nature, both in type and in number, and thus further enhance the security of the ID authentication process. Many other types and combinations of biometric and non-biometric data suitable for authentication will become apparent to those skilled in the art, and all such types and combinations of data are intended to be within the scope of the present disclosure.

In the embodiments described above, purchaser 102 is contacted by ID authentication server 200 via a cellular telephone. The exchange of sampled data, however, may also be performed using devices provided at the point-of-sale by the merchant. If purchaser 102 is at a brick and mortar store, for example, the merchant may provide devices that are coupled to the internet for providing the needed real-time biometric samples. ID authentication server 200 then has the option of contacting the purchaser using the point-of-sale device. The information need to locate the device on the Internet may be maintained within a database (not shown) stored on non-volatile storage device 206, or may be provided as part of the ID authentication request received by the ID authentication server 200. ID authentication software 212 may be configured to randomly choose between using the point-of-sale device or the cell phone to communicate with the purchaser/holder, and may also randomly select the type, number and specific responses solicited. Similar devices coupled to a personal computer may also be used by a purchaser making a purchase via the Internet.

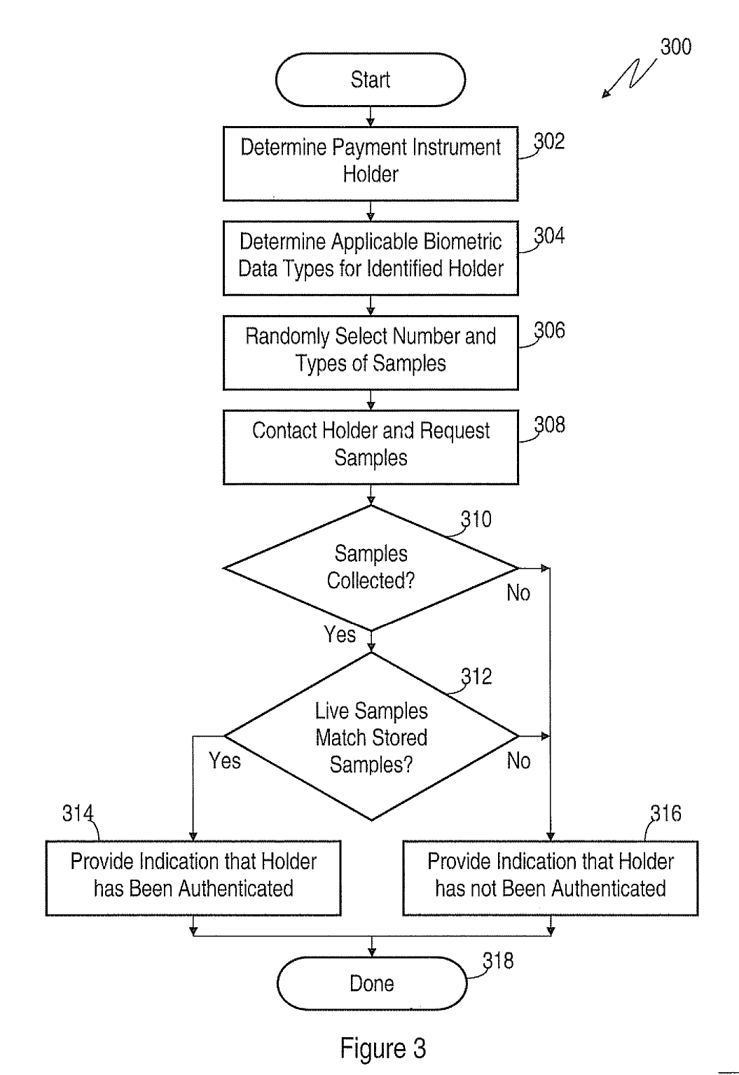

As noted above, ID verification software 212 of FIG. 2 executes on processor 202, processing ID authentication requests and exchanging information with the purchaser/holder to confirm the identity and authorization of the party presenting a payment instrument to a merchant. FIG. 3 shows a method 300 for performing functions such as those performed by ID authentication software 212 of FIG. 2, in accordance with at least some illustrative embodiments of the invention. After determining who the holder of record is for the payment instrument for which ID authentication is requested (block 302), a determination is made as to what type of biometric data can be used to authenticate the identity of the purchaser presenting the payment instrument (block 304). As previously described, this depends upon the capabilities of the device used to communicate with the holder of record, and may be determined from information stored within a database containing information regarding the holder (e.g., cardholder database 218 of FIG. 2).

Continuing to refer to FIG. 3, once the type of data that can be requested is determined, the types of samples that will actually be requested of the holder are randomly selected (block 306). The holder of record is contacted and prompted to provide real-time biometric samples (block 308) based upon the selection made in block 306. For example, if a holder is contacted via a cellular telephone, only a voice response to one of a plurality of authentication questions or prompts is presented to the holder. The number of questions or prompts available for verification will depend upon the number of stored responses the user has previously saved in the system. The more stored responses the holder has configured and saved, the greater the variety and randomness of the query, which improves the overall security of the method 300. In other embodiments where additional devices are available for collecting a real-time biometric data sample (e.g., a fingerprint scanning device coupled to a laptop that also couples to a microphone), a random voice response may be requested together with a fingerprint sample randomly selected from one of the holder's ten fingers.

If a sample is not successfully collected (block 310), or if a sample is successfully collected but at least one sample does not match the corresponding response stored in the biometric database for the holder (block 312), an indication is generated signaling that the holder has not been authenticated (block 316), and the method ends (block 318). Similarly, if a sample is successfully collected (block 310) and all the collected samples match the corresponding stored samples (block 312), an indication is generated signaling that the holder has been authenticated (block 314) and the method ends (block 318). The described indications may be, for example, in the form of a flag within a message sent to a credit authorization agent (e.g., credit authorization agent 106 of FIG. 1) in response to an ID authentication request.

It should be noted that although the illustrative embodiments described utilize stored samples randomly selected from a fixed number of stored samples, other illustrative embodiments may allow for the progressive addition of additional stored samples. For example, after being authenticated a holder may be prompted for a new stored sample, which is then added to the biometric database. Each time a transaction is successfully authenticated (or at some other less intrusive interval, such as every 5^{th} authenticated transaction), the holder may be prompted for a new sample that is saved. Over time the number of samples in the biometric database grows, increasing the degree of randomness of the selection, and thus increasing the degree of security provided by the authentication.

The above disclosure is meant to be illustrative of the principles and various embodiments of the present invention. Numerous variations and modifications will become apparent to those skilled in the art once the above disclosure is fully appreciated. For example, although the embodiments presented describe a method wherein the holder of record of the payment instrument presented is the party contacted for authentication purposes, other embodiments are contemplated wherein the purchaser is contacted, based upon information provided when the payment instrument is presented. If the purchaser is not the holder of record, the authentication will fail, since the stored samples are provided by the holder of record and the random selection of the samples requested make falsification of the requested sample very difficult and impractical. It is intended that the following claims be interpreted to embrace all such variations and modifications.

What is claimed is:

1. A method, comprising:
determining which of a plurality of real-time biometric data sample types can be provided by a holder of a payment instrument;
randomly selecting a first stored biometric data sample from a plurality of stored biometric data samples;
soliciting a first real-time biometric data sample from the holder corresponding to the first stored biometric data sample; and
authenticating the identity of the holder if the first real-time biometric data sample matches the first stored biometric data sample.

2. The method of claim 1, further comprising not authenticating the identity of the holder if the first real-time biometric data sample does not match the first stored biometric data sample.

3. The method of claim 1, wherein the first stored biometric data sample comprises a voice recording of the holder made in response to a prompt, and wherein the prompt is presented to the holder when soliciting the first real-time biometric data sample.

4. The method of claim 1, further comprising:
randomly selecting a second stored biometric data sample from the plurality of stored biometric data samples; and
soliciting a second real-time biometric data sample from the holder corresponding to the second stored biometric data sample.

5. The method of claim 4, wherein randomly selecting the first and second stored biometric data samples comprises randomly selecting from a plurality of stored biometric data samples of a single sample type.

6. The method of claim 4, wherein randomly selecting the first and second stored biometric data sample comprises randomly selecting from a plurality of stored biometric data samples of two or more sample types.

7. The method of claim 6, wherein the first selected stored biometric data sample is of a different sample type from the sample type of the second selected stored biometric data sample.

8. The method of claim 1, wherein the holder of the payment instrument from which the biometric data sample is solicited is selected from a list of holders, and wherein the method is repeated for each holder of the list of holders until the identity of a selected holder is authenticated or until the end of the list of holders is reached.

9. The method of claim 1, wherein the holder of the payment instrument from which the biometric data sample is solicited is selected from a list of holders, and wherein the method is repeated for each holder of the list of holders until the identities of two or more selected holders are authenticated or until the end of the list of holders is reached.

10. An Information carrier medium comprising software that can be executed on a processor to cause the processor to:
determine which of a plurality of real-time biometric data sample types can be provided by a holder of a payment instrument;
randomly select a first stored biometric data sample from a plurality of stored biometric data samples;
solicit a first real-time biometric data sample from the holder corresponding to the first stored biometric data sample; and
authenticate the identity of the holder if the first real-time biometric data sample matches the first stored biometric data sample.

11. The information carrier medium of claim 10, wherein the software further causes the processor to not authenticate the identity of the holder if the first real-time biometric data sample does not match the first stored biometric data sample.

12. The information carrier medium of claim 10, wherein the first stored biometric data sample comprises a voice recording of the holder made in response to a prompt, and wherein the prompt is presented to the holder when soliciting the first real-time biometric data sample.

13. The information carrier medium of claim 10, wherein the software further causes the processor to:
randomly select a second stored biometric data sample from the plurality of stored biometric data samples; and
solicit a second real-time biometric data sample from the holder corresponding to the second stored biometric data sample.

14. The information carrier medium of claim 13, wherein causing the processor to randomly select the first and second stored biometric data samples comprises causing the processor to randomly select from a plurality of stored biometric data samples of a single sample type.

15. The information carrier medium of claim 13, wherein causing the processor to randomly select the first and second stored biometric data samples comprises causing the processor to randomly select from a plurality of stored biometric data samples of two or more sample types.

16. The information carrier medium of claim 15, wherein the first selected stored biometric data sample is of a different sample type from the sample type of the second selected stored biometric data sample.

17. The information carrier medium of claim 10, wherein the holder of the payment instrument from which the biometric data sample is solicited is selected from a list of holders, and wherein the method is repeated for each holder of the list of holders until the identity a selected holder is authenticated or until the end of the list of holders is reached.

18. The information carrier medium of claim 10, wherein the holder of the payment instrument from which the biometric data sample is solicited is selected from a list of holders, and wherein the software causes the processor to process each holder of the list of holders until the identities of two or more selected holders are authenticated or until the end of the list of holders is reached.

19. A computer system, comprising:
a processor;
a communications interface coupled to the processor and configured to exchange messages across a communications network, wherein at least some of the messages identify a holder of a payment instrument;
a non-volatile storage device coupled to the processor;
one or more stored biometric data samples maintained on the non-volatile storage device; and
software executing on the processor and configured to transmit and received messages using the communications interface, and further configured to store and retrieve the one or more biometric data samples;
wherein the holder is prompted by the software to provide one or more randomly selected real-time biometric data samples, each corresponding to one of the one or more stored biometric data samples; and
wherein the identity of the holder is authenticated if each of the one or more real-time biometric samples matches the corresponding one or more stored biometric samples.

20. The computer system of claim 19, wherein the identity of the holder is not authenticated if at least one of the one or more real-time biometric samples does not match the corresponding one or more stored biometric samples.
